(19) United States
(12) Patent Application Publication
(10) Pub. No.: US 2010/0257687 A1
(43) Pub. Date: Oct. 14, 2010

(54) FLAT BLADE WIPER FOR VEHICLE

(76) Inventor: Shih-Hsien HUANG, Kaohsiung City (TW)

Correspondence Address: BACON & THOMAS, PLLC, 625 SLATERS LANE, FOURTH FLOOR, ALEXANDRIA, VA, 22314-1176, US

(21) Appl. No.: 12/604,183

(22) Filed: Oct. 22, 2009

Related U.S. Application Data
(60) Provisional application No. 61/202,851, filed on Apr. 13, 2009.

(51) Int. Cl. B60S 1/40; B23P 17/04

(52) U.S. Cl. 15/250.32; 29/428

(57) ABSTRACT

A flat blade wiper for a vehicle includes a rigid elastic metal keelson strip, a saddle bracket for receiving a wiper adapter, an elongated scraping blade with an upper wing section, two rigid hard clipping sleeve mounts, and a pair of end positioning caps. Each clipping sleeve mount and wiper adapter saddle bracket has first compatible accommodating channels and second accommodating channels respectively so that the elastic metal keelson strip can run through the first accommodating channels while the upper wing section of the elongated scraping blade can run through the second accommodating channels in both the wiper adapter saddle bracket and the clipping sleeve mount. When the wiper swings back and forth, an acting force is directly transmitted to the clipping sleeve mounts by the metal keelson strip without any pause or delay, eliminating jerking so that no noise is incurred to spoil the internal tranquility of the vehicle.

This application claims the benefit of provisional U.S. patent application Ser. No. 61/202,851, field Apr. 13, 2009.

### FIELD OF THE PRESENT INVENTION

The present invention relates to a flat blade wiper that can directly transmit an acting force, when the wiper swings back and forth, to clipping sleeve mounts by a metal keelson strip without any pause or delay and without jerking. In addition, alignment of key components of the wiper can be achieved without the need for extreme carefulness so that fatigue of the assembling operator can be considerably reduced. Accordingly, not only can assembling time be saved, but assembling efficiency is also increased. Consequently, the manufacturing cost is decreased and marketing competition ability is increased.

### BACKGROUND OF THE INVENTION

Normally, the evolution of the windshield wiper for vehicles is from the traditional “frame supported wiper” to the modern “non-framed wiper”, colloquially known as a “flat blade wiper”. The “frame supported wiper” usually includes a U-shaped metal strip called a metal blade frame with a slot along the length of the frame for holding a rubber blade to serve as an exposed supporting keel for the associated rubber blade, whereas a flat metal strip for the “non-framed wiper” is imbedded in a soft elastic clipping sleeve sheath, which actually holds a rubber blade, to serve as an enveloped keelson for the associated rubber blade. Recently, most windshield wipers included in newly marketed vehicles have been “non-framed wipers”. The “frame supported wiper” has seemingly become phased-out in the market because it involves more components with heavier weight and more power consumption, as well as a greater possibility of jerking noise due to swinging friction on the windshield after a certain service time and corrosion resulting from weathering of the exposed metal blade frame. Moreover, the windshield wiper belongs to consumptive products, which require replacement when its wiping declination due to aging may affect the driving safety. The accumulated quantity of defective wipers of the annually-replaced “frame supported wiper” type has become a heavy burden on the environment. In contrast, the “non-framed wiper” does not present such a burden on the environment.

Accordingly, various “non-framed wipers” such as those described in USA utility patents U.S. Pat. No. 6,523,218, U.S. Pat. No. 6,944,905, U.S. Pat. No. 7,228,588, U.S. Pat. No. 7,055,206, U.S. Pat. No. 7,305,734, U.S. Pat. No. 7,484,264 and U.S. Pat. No. 7,210,189, as well as USA design patents Des. U.S. Pat. Nos. 430,097, D512,362, D457,479, D443,854, D511,735, D564,4345, D5,649,555, D5,794,015 and D5,798,495 have been well-developed. Among those “non-framed wipers” mentioned above, U.S. Pat. No. 7,210,189 discloses the newest type of “non-framed wiper,” shown in FIGS. 1 through 6 of the present application. As described in the “Detailed Description of Preferred Embodiment of the Present Invention” in U.S. Pat. No. 72,101,189, the windshield wiper comprises two blade bodies 6, a flat metal vertebra 7 with rectangular cross section, a rubber element 9 and a central support 10 wherein:

Said blade body 6 consists in a flexible upper support 4 and a semi-rigid lower support 5. Joining the upper support 4 and the lower support 5 by co-extrusion assures the single piece formed an integral support to the other components of the blade system including the metal vertebra 7 and the rubber element 9, in which, said upper support 4 includes a mounting channel 8, passing lengthwise throughout the length of the blade body 6, being preferably rectangular in shape, inside of which the metal vertebra 7 is inserted, also having preferably rectangular and flat profile and shape, being used for securing and keeping the element 9 in uniform contact with the windshield 3, said lower support 5 includes a lower mounting channel 12, passing lengthwise throughout the length of the blade body 6, being preferably rectangular in shape and further provided with a longitudinal rectangular opening 13 extending throughout the blade body 6, in which the rectangular upper section 16 with central neck of the rubber element 9 is inserted through the rectangular upper section 15 and the longitudinal rectangular opening 13 (as shown in FIGS. 1 through 3); and

Said central support 10, which is made of metallic or plastic material to be adjusted to the adapter of wiper arm 2 of the windshield wiper 3, comprises an upper mounting channel 11 and a lower passage channel 14 such that said upper mounting channel 11, passing lengthwise throughout the length of the central support 10, being preferably rectangular in shape, inside of which the metal vertebra 7 is inserted, and said passage channel 14, passing lengthwise throughout the length of the central support 10, being preferably rectangular in shape and further provided beneath with a longitudinal rectangular opening 15 extending throughout the sequential central support 10, in which the rectangular upper section 16 of the rubber element 9 is inserted through (as shown in FIGS. 2 and 3).

Please refer to FIGS. 2 through 6, which describes the assembly procedure for the conventional non-framed windshield wiper disclosed in U.S. Pat. No. 7,210,189.

Firstly, pass the mounting channel 11 of the central support 10 through the metal vertebra 7 up to the central position thereof, then fix the central support 10 at the central position of the metal vertebra 7 by bolts or rivets (as shown in FIG. 6);

Secondly, insert each end of the metal vertebra 7 into corresponding mounting channel 8 in the upper support 4 of the blade body 6 (as shown in FIG. 4) so that each half of the metal vertebra 7 is enveloped by a blade body 6 (as shown in FIG. 6); and

Finally, insert each rectangular upper section 16 of the rubber element 9 into corresponding lower mounting channel 12 and passage channel 14 and the longitudinal rectangular opening 13 and 15 on the blade body 6 and the central support 10 (as shown in FIG. 5), so that the entire windshield wiper is successfully assembled (as shown in FIG. 3).

Despite the above-described advantages, the conventional non-framed windshield wiper disclosed in U.S. Pat. No. 7,210,189 has the following drawbacks:

1. As shown in FIGS. 7 to 7e, when the rubber element 9 is pushed over the windshield 3 by the wiper arm 2, a normal force component Fv is exerted on the blade body 6 so that the wiping edge of the rubber element 9 is tightly pressed against the top surface of the windshield 3 (as shown in FIG. 7); Because the wiper arm 2 swings back and forth during rain, the metal vertebra 7 has a forward horizontal force component Fh exerted on the blade body 6 (as shown in FIG. 7a) when wiper arm 2 swings forth; whereas the metal vertebra 7 has a backward horizontal force component Fh′ exerted on the blade body 6 (as shown in the hypothetical line of the FIG. 7c) upon wiper arm 2 swinging back. As a result, the action of the forward horizontal force component Fh and the backward horizontal force component Fh′ will be indirectly applied to the rubber element 9 in the following order: first, via the flexible upper support 4 and semi-rigid lower support 5, and second via the blade body 6 so that the wiping edge of the rubber element 9 will wipe over the top surface of the windshield 3 to achieve the wiping effect.

When forward horizontal force component Fh is exerted on the blade body 6 by the metal vertebra 7, the right side of the upper mounting channel 8 in the soft flexible upper support 4 of the blade body 6 is laterally affected by the right side of the metal vertebra 7 which is in contact with and pushes on the upper mounting channel 8, while the left side of the upper mounting channel 8 is detached and not laterally affected by the left side of the metal vertebra 7 (as shown in FIG. 7a). Because the action of the forward horizontal force component Fh and the backward horizontal force component Fh′ is indirectly applied to the rubber element 9 in sequence via the upper support 4 and lower support 5 of the blade body 6, the wiping edge of the rubber element 9 will wipe over the top surface of the windshield 3 so that when wiper arm 2 swings forth, the right side of the upper mounting channel 8 in the soft flexible upper support 4 will be deformed in a stretchable manner due to squeezing by the right side of the metal vertebra 7 while the left side of the upper mounting channel 8 in the soft flexible upper support 4 will be deformed with a gap 6 left between the left side of the upper mounting channel 8 and the left side of the metal vertebra 7 (as shown in FIG. 7b). When wiper arm 2 swings back, the backward horizontal force component Fh′ will convert the situation so that the right side of the upper mounting channel 8 in the soft flexible upper support 4 of the blade body 6 is detached and will not be laterally affected by the right side of the metal vertebra 7 while the left side of the upper mounting channel 8 is laterally affected by the left side of the metal vertebra 7 by contact and pushing (as shown in FIG. 7c and the hypothetical line of the FIG. 7d); Likewise, when wiper arm 2 swings back, the left side of the upper mounting channel 8 in the soft flexible upper support 4 will be deformed in stretchable manner due to squeezing by the left side of the metal vertebra 7 while the right side of the upper mounting channel 8 in the soft flexible upper support 4 will be deformed with a gap δ′ left between the right side of the upper mounting channel 8 and the right side of the metal vertebra 7 (as shown in FIG. 7e).

In other words, both the deformed gap δ and gap δ′ between each of both sides of the upper mounting channel 8 and each of corresponding both sides of the metal vertebra 7 will be alternately created by the forward horizontal force component Fh and backward horizontal force component Fh′ from wiper arm 2 swinging back and forth. Consequently, the transmission delay of the exerting force due to both deformed gaps δ and δ′ will cause a temporary wiping pause and jerking of the rubber element 9 over the top surface of the windshield 3 so that a harsh scraping noise is incurred to spoil the tranquility in the vehicle. Moreover, because the swing frequency of the normal windshield wiper over the vehicle windshield 3 is 40˜50 times per minute, namely 2400˜3000 times per hour, the foregoing temporary wiping pause and jerking of the rubber element 9 over the top surface of the windshield 3 will follow in same frequency accordingly. Thus, the service life of the rubber element 9 in the windshield wiper will be shortened due to the high frequency of temporary wiping pauses and jerks, with the result that the replacing frequency and cost increases.

Inspecting and reviewing the foregoing drawbacks in the conventional windshield wiper disclosed in U.S. Pat. No. 7,210,189, the primary cause is that the exerting force of the metal vertebra 7 from the wiper arm 2 is indirectly applied to the semi-rigid lower support 5 via soft flexible upper support 4 instead of being directly applied to the semi-rigid lower support 5. Therefore, a transmission delay of the exerting force due to both deformed gap δ and gap δ′ in the soft flexible upper support 4 is inevitable, due to deformation of the soft flexible material so that a temporary wiping pause or delay with jerking of the rubber element 9 over the top surface of the windshield 3 results. Such a bad structural design not only violates the transmission rule in dynamics but also brings bad effects, as mentioned above, for consumers.

Turning to FIGS. 4 to 6, which describe the assembly procedure for the conventional windshield wiper of U.S. Pat. No. 7,210,189, because the outer dimensional size of the metal vertebra 7 is only slightly smaller than the inner dimensional size of corresponding upper mounting channel 8 in the upper support 4 of the blade body 6, both coupling ends of the metal vertebra 7 and upper mounting channel 8 must be aligned with each other during the assembly procedure and kept in a horizontal state (as shown in FIG. 4) to enable the insertion of the metal vertebra 7 into the blade body 6 successfully. However, the windshield wiper is a low selling price product that is mass produced with annual quantity over several ten million pieces to cover the total demand for new vehicles and used vehicles. Since the assembly procedure of the metal vertebra 7 with the blade body 6 requires great care in alignment, the assembling operator must pay more attention and waste more time to maintain an acceptable yield. Accordingly, not only does the assembling operator get fatigued easily, but the assembling efficiency is also decreased, with the result that the manufacturing cost is increased and marketing competition ability is decreased.

### SUMMARY OF THE INVENTION

The primary object of the present invention is to provide a flat blade wiper that s a rigid elastic metal keelson strip, a saddle bracket for a wiper adapter, an elongated scraping blade with an upper wing section, two rigid hard clipping sleeve mounts and a pair of end positioning caps, wherein each clipping sleeve mount and saddle bracket for a wiper adapter has a first compatible accommodating channel and a second accommodating channel, respectively, so that the elastic metal keelson strip can run through the first accommodating channels while the upper wing section of the elongated scraping blade can run through the second accommodating channels on both the wiper adapter saddle bracket and the clipping sleeve mount. When the wiper swings back and forth, an acting force can be directly transmitted to the clipping sleeve mounts by the metal keelson strip without any pause, delay, or jerking phenomenon so that no noise is incurred to spoil the internal tranquility of vehicle. Thus, not only can the power burden of the wiper arm be saved, but the replacement cost can also be reduced, resulting in extension of the service life of the wiper.

Another object of the present invention is to provide a flat blade wiper with reduced width in each adapted guide section to serve as an alignment precursor for the docking procedure between key components of the wiper, including the clipping sleeve mount and elastic metal keelson strip, via corresponding ends respectively. Even though the components are not in exact linear alignment with each other, the docking procedure can still be performed quickly and easily. Because of the aforesaid features, the alignment procedure for key components of the wiper does not need extra care so that the fatiguing attention of the assembling operator can be considerably reduced. Accordingly, not only can the assembling time be saved, but the assembling efficiency is also increased. Consequently, the manufacturing cost is decreased and marketing competition ability is increased.

### BRIEF DESCRIPTION OF THE DRAWINGS

FIG. 1 is a perspective view of a blade body for the conventional windshield wiper of U.S. Pat. No. 7,210,189.

FIG. 2 is a perspective view of a central support for the conventional windshield wiper of U.S. Pat. No. 7,210,189.

FIG. 3 is an assembly view of the conventional windshield wiper shown in U.S. Pat. No. 7,210,189.

FIG. 4 is a first illustration of a perspective assembly view of the conventional windshield wiper shown in U.S. Pat. No. 7,210,189.

FIG. 5 is a second illustration of a perspective assembly view for the conventional windshield wiper shown in U.S. Pat. No. 7,210,189.

FIG. 6 is a third illustration of a perspective assembly view for the conventional windshield wiper shown in U.S. Pat. No. 7,210,189.

FIG. 7 is a first illustration of an operational view for the conventional windshield wiper shown in U.S. Pat. No. 7,210,189.

FIG. 7a is a second illustration of an operational view of the conventional windshield wiper shown in U.S. Pat. No. 7,210,189.

FIG. 7b is a third illustration of an operational view of the conventional windshield wiper shown in U.S. Pat. No. 7,210,189.

FIG. 7c is a fourth illustration of an operational view of the conventional windshield wiper shown in U.S. Pat. No. 7,210,189.

FIG. 7d is a fifth illustration of an operational view of the conventional windshield wiper shown in U.S. Pat. No. 7,210,189.

FIG. 7e is a sixth illustration of an operational view of the conventional windshield wiper shown in U.S. Pat. No. 7,210,189.

FIG. 8 is an exploded perspective of a flat blade wiper for a vehicle according to a first preferred embodiment of the present invention.

FIG. 8a is a sectional view taken along line 8a-8a as indicated in FIG. 8.

FIG. 9 is a perspective view of the saddle bracket for a wiper adapter of the above first preferred embodiment of the present invention.

FIG. 9a is an elevation view taken along the direction 9a as indicated in FIG. 9.

FIG. 9b is a sectional view taken along line 9b-9b as indicated in FIG. 9.

FIG. 9c is a sectional view taken along line 9c-9c as indicated in FIG. 9.

FIG. 9d is a bottom view taken along the direction 9d as indicated in FIG. 9.

FIG. 10 is a perspective view of an end positioning cap of the first preferred embodiment of the present invention.

FIG. 10a is an elevation view taken along the direction 10a as indicated in FIG. 10.

FIG. 10b is a sectional view taken along line 10b-10b as indicated in FIG. 10.

FIG. 10c is a sectional view taken along line 10c-10c as indicated in FIG. 10.

FIG. 10d is a sectional view taken along line 10d-10d as indicated in FIG. 10.

FIG. 10e is a bottom view taken along the direction 10e as indicated in FIG. 10.

FIG. 11 is a first illustration of a perspective assembly view of the above first preferred embodiment of the present invention.

FIG. 11a is a first illustration of a planar assembly view for the combination of the elastic metal keelson strip and the end positioning cap of the above first preferred embodiment of the present invention.

FIG. 11b is a second illustration of a planar assembly view for the combination of the elastic metal keelson strip and the end positioning cap of the above first preferred embodiment of the present invention.

FIG. 11c is a third illustration of a planar assembly view for combination of the elastic metal keelson strip and the end positioning cap of the above first preferred embodiment of the present invention.

FIG. 12 is a second illustration of a perspective assembly view of the first preferred embodiment of the present invention.

FIG. 12a is a sectional view taken along line 12a-12a as indicated in FIG. 12.

FIG. 13 is a third illustration of a perspective assembly view of the first preferred embodiment of the present invention.

FIG. 13a is a sectional view taken along line 13a-13a as indicated in FIG. 13.

FIG. 14 is a fourth illustration of a perspective assembly view of the first preferred embodiment of the present invention.

FIG. 14a is a sectional view taken along line 14a-14a as indicated in FIG. 14.

FIG. 15 is a fifth illustration of a perspective assembly view of the first preferred embodiment of the present invention.

FIG. 15a is a sectional view taken along line 15a-15a as indicated in FIG. 15.

FIG. 16 is a sixth illustration of a perspective assembly view of the first preferred embodiment of the present invention.

FIG. 16a is a sectional view taken along line 16a-16a as indicated in FIG. 16.

FIG. 17 is a first illustration of a perspective assembly view for the combination of the elastic metal keelson strip and the clipping sleeve mount of the first preferred embodiment of the present invention.

FIG. 17a is the second illustration of a perspective assembly view for the combination of the elastic metal keelson strip and the clipping sleeve mount of the first preferred embodiment of the present invention.

FIG. 17b is a third illustration of a perspective assembly view for the combination of the elastic metal keelson strip and the clipping sleeve mount of the above first preferred embodiment of the present invention.

FIG. 18 is a sectional view taken along line 18-18 as indicated in FIG. 17.

FIG. 18a is a sectional view taken along line 18a-18a as indicated in FIG. 17a.

FIG. 18b is a sectional view taken along line 18b-18b as indicated in FIG. 17b.

FIG. 19 is a perspective view for the combination of the wiper arm and the first preferred embodiment of the present invention.

FIG. 20 is a sectional view taken along line 20-20 as indicated in FIG. 19, illustrating the first preferred embodiment of the present invention acting on the windshield of the vehicle.

FIG. 21 is an operational view showing the first preferred embodiment of the present invention acting on the windshield of the vehicle.

FIG. 22 is an exploded perspective view of a flat blade wiper for a vehicle according to a second preferred embodiment of the present invention.

FIG. 22a is a sectional view taken along line 22a-22a as indicated in FIG. 22.

FIG. 23 is a perspective assembly view of the second preferred embodiment of the present invention.

FIG. 23a is a sectional view taken along line 23a-23a as indicated in FIG. 23.

FIG. 24 is a sectional plan view of an alternative mode of the clipping sleeve mount of the present invention.

FIG. 25 is a sectional plan view of an alternative mode of the clipping sleeve mount of the present invention acting on the windshield of the vehicle.

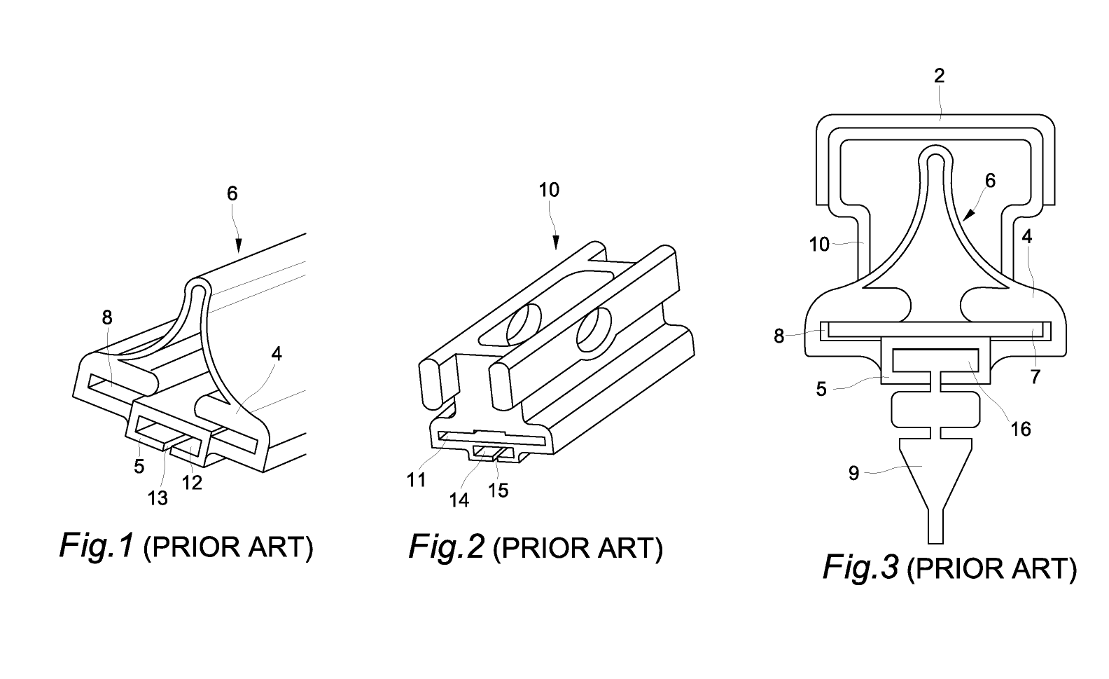

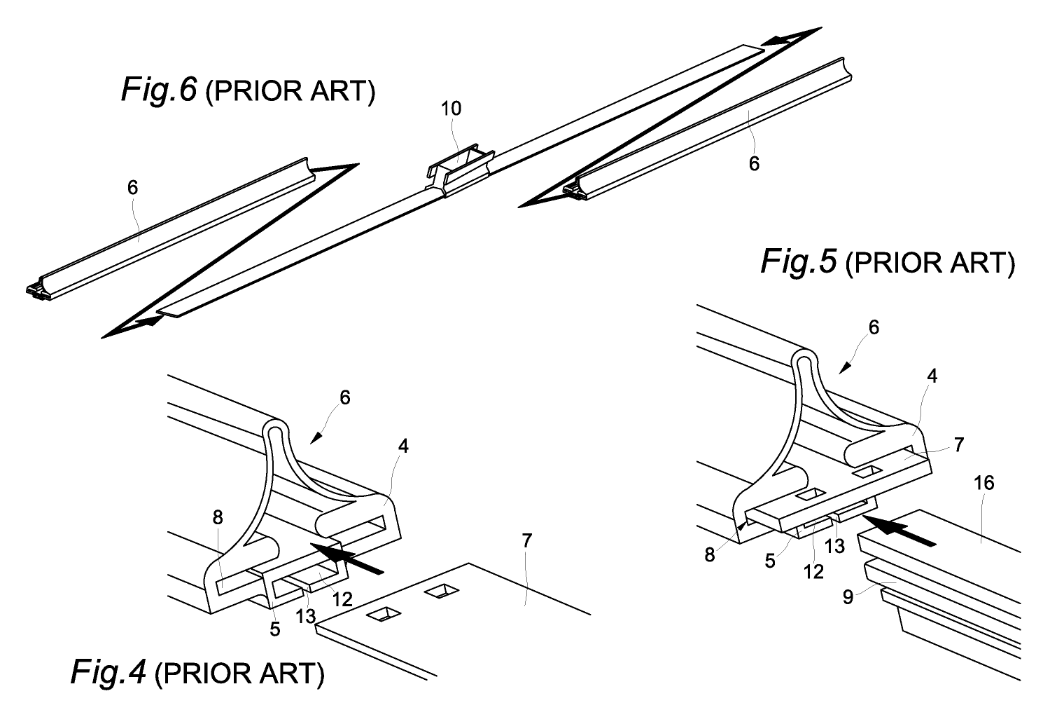

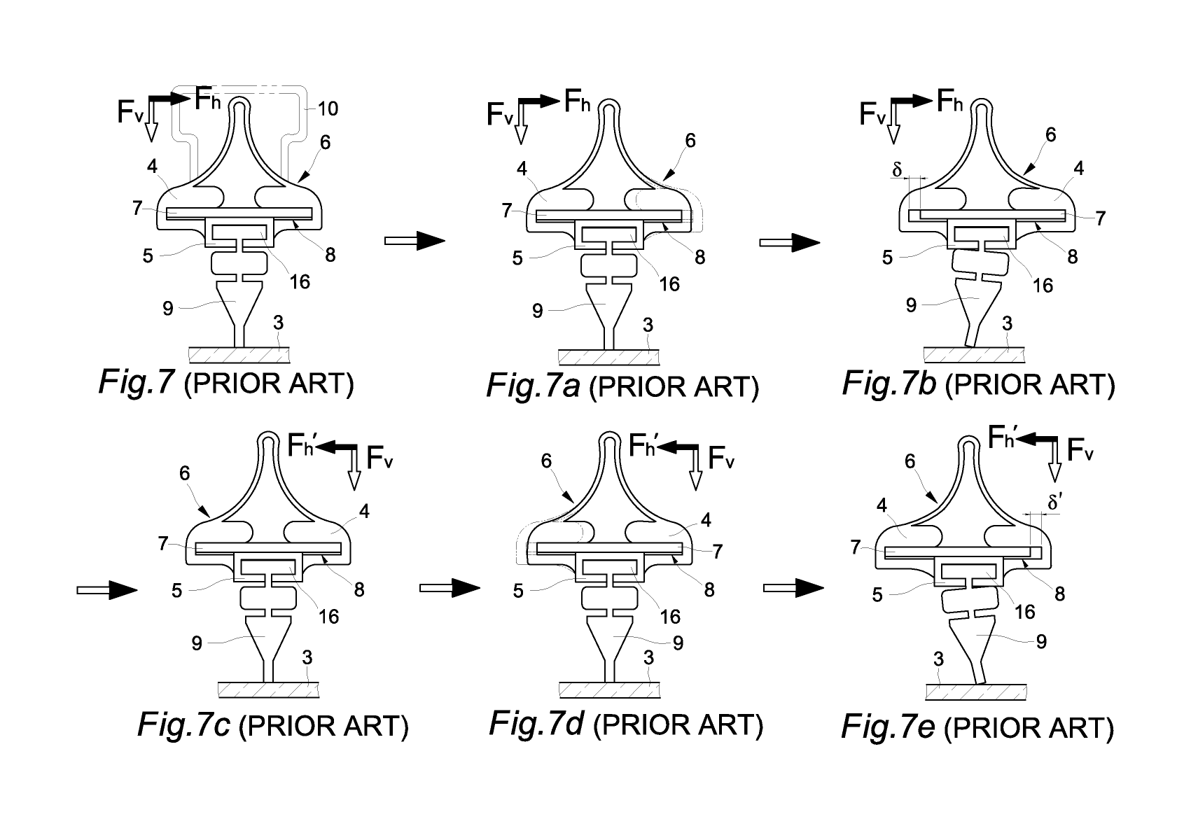

### DETAILED DESCRIPTION OF THE PREFERRED EMBODIMENTS

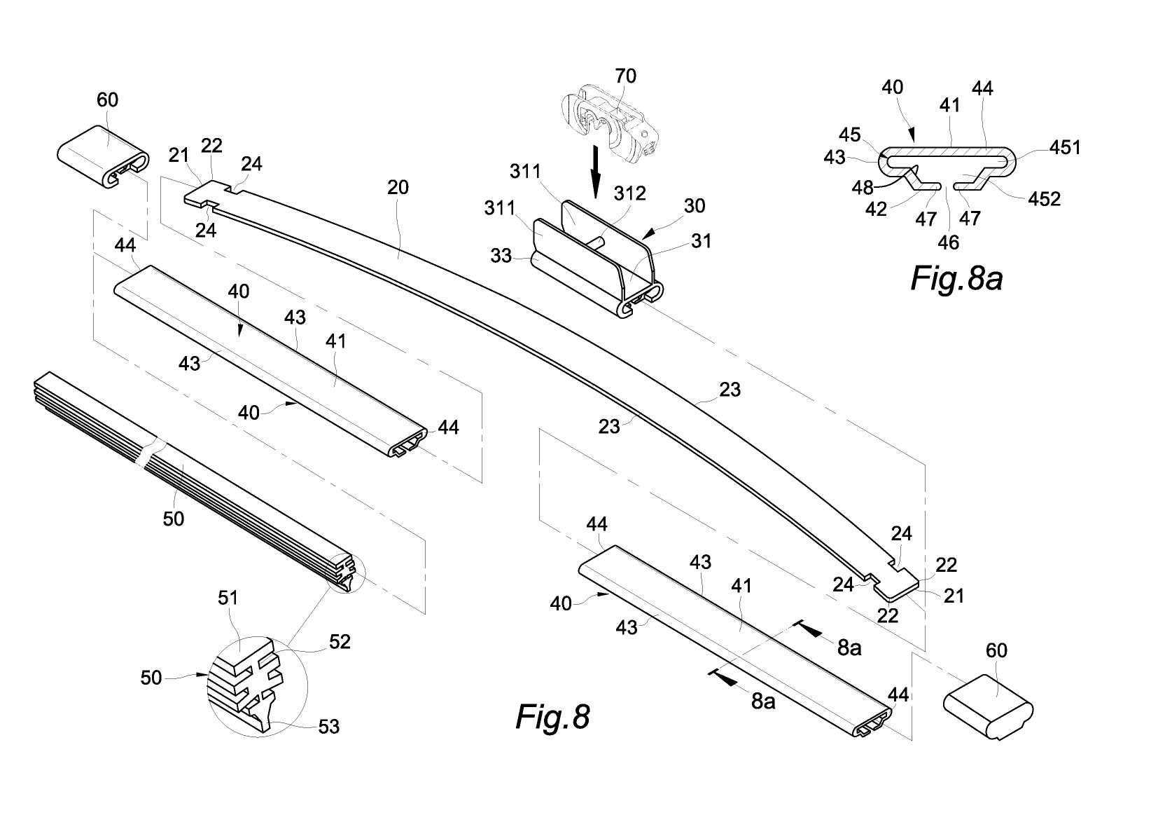

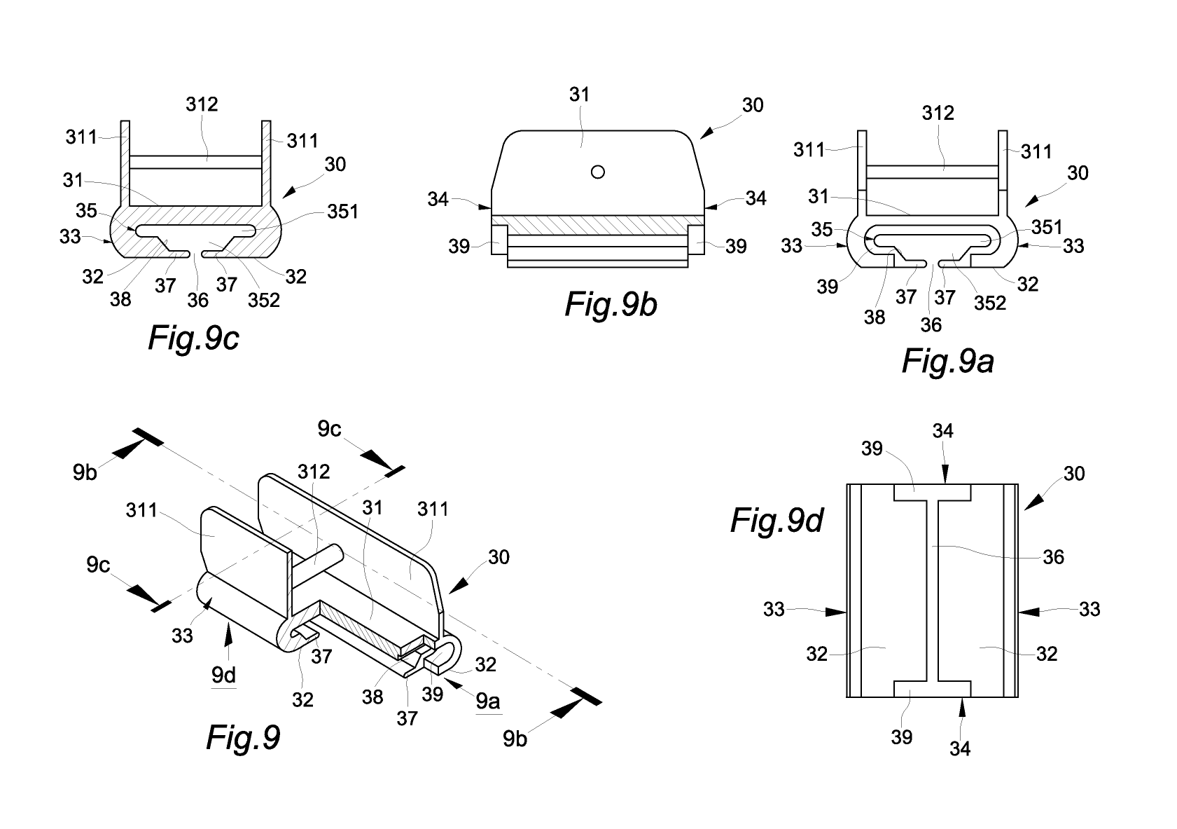

Referring to FIGS. 8, 9 and 10, a flat blade wiper for a vehicle (colloquially called as non-framed windshield wiper) according to a first preferred embodiment of the present invention comprises an elastic metal keelson strip 20, a saddle bracket 30 for a wiper adapter, two clipping sleeve mounts 40, an elongated scraping blade 50 and a pair of end positioning caps 60.

Referring to FIGS. 8, 9 through 9d and 10 through 10e, the elastic metal keelson strip 20 is a flat flexible metal band of yoke-like shape profile with two ends extending downwardly, and has a pair of short transverse edges 21, a pair of long lengthwise edges 23, a pair of adapted guide sections, two pairs of rounded shoulders 22 and two pairs of notches 24, wherein each said adapted guide section, which are located at each distal end of the elastic metal keelson strip 20, is flanked by a pair of rounded shoulders 22; and each pair of notches 24 is located at joint sides of the long lengthwise edges 23 and corresponding rounded shoulders 22.

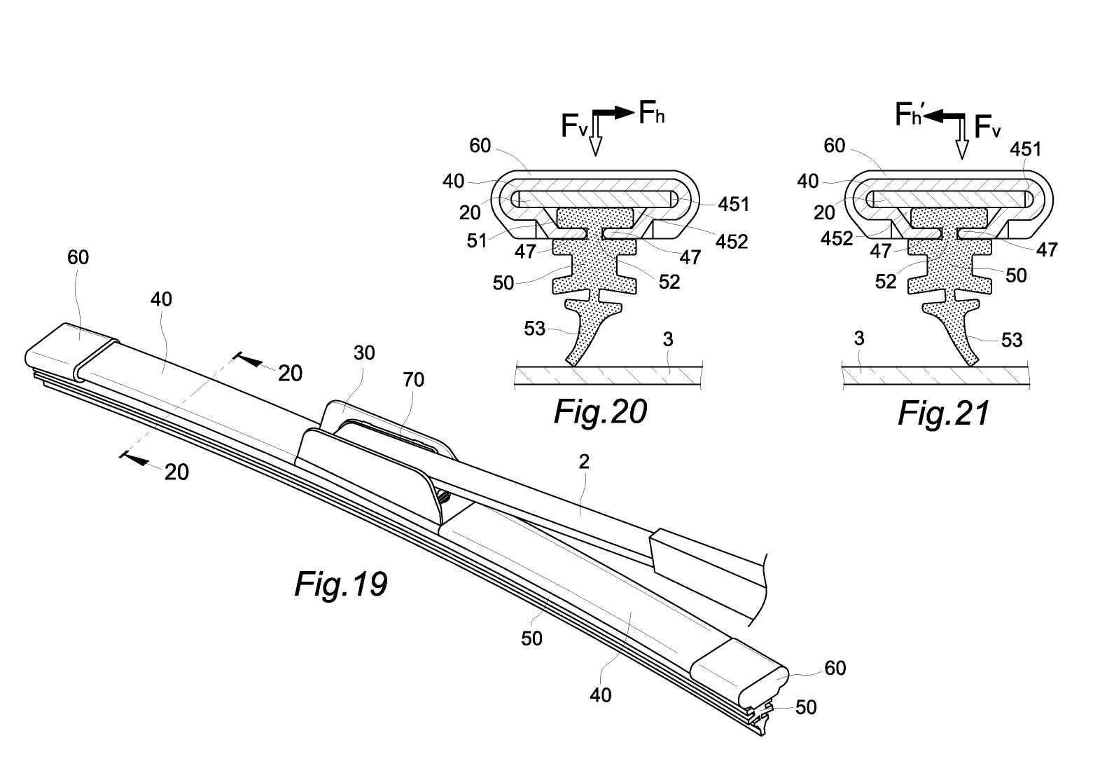

The wiper adapter saddle bracket 30 is a unitary extruded plastic parallelepiped with a top surface 31, a bottom sole 32, two long lengthwise shoulders 33 and two short transverse sides 34, and has a pair of upright cheeks 311, an accommodating channel 35 including an upper first accommodating channel 351 and a lower second accommodating channel 352, a longitudinal gap 36, a pair of horizontal clipping juts 37, a pair of symmetric bevels 38 and a pair of widened-slotted inlets 39, wherein a pair of upright cheeks 311 are juxtaposed on the top surface 31 such that each upright cheek 311 is near each corresponding long lengthwise shoulder 33, and a supporting spindle 312 is configured between the two upright cheeks 311 for coupling to a wiper adapter 70 linked to a wiper arm 2 (as shown in FIG. 19). An accommodating channel 35 is situated between the top surface 31 and bottom sole 32 and extends towards both short transverse sides 34 such that the upper first accommodating channel 351 is wider than the lower second accommodating channel 352. The first accommodating channel 351, which is a flat upper space of the accommodating channel 35 near top surface 31, is dimensioned to have a width and height slightly bigger than the width and height of the elastic metal keelson strip 20 so that the elastic metal keelson strip 20 can be inserted therein. The second accommodating channel 352, which is an adapted flat lower space of the accommodating channel 35, is dimensioned to have a width and height slightly bigger than the width and height of the upper wing section 51 on the elongated scraping blade 50 so that the upper wing section 51 on the elongated scraping blade 50 can be inserted therein. The longitudinal gap 36 is created between the second accommodating channel 352 and bottom sole 32 in parallel with the two long lengthwise shoulders 33 so that the middle neck section 52 in the upper wing section 51 of the elongated scraping blade 50 can be inserted therein. The pair of horizontal clipping juts 37 are created between the external wall of the bottom sole 32 and internal wall of the second accommodating channel 352 to abut against both sides of the longitudinal gap 36 in parallel juxtaposition manner. The pair of symmetric bevels 38 are created between the internal wall of the upper first accommodating channel 351 and internal wall of the lower second accommodating channel 352 in symmetric manner such that the angle formed by each symmetric bevel 38 along each internal wall of the corresponding first accommodating channel 351 and each internal wall of the corresponding second accommodating channel 352 is an obtuse angle. The widened-slotted inlets 39 each extends inwardly in a corresponding short transverse side 34 with a bottom front edge cutout, with a cross section profile of the inlets 39 being the same as that of the short transverse side 44 on the clipping sleeve mount 40, but with internal dimension being slightly bigger than the external dimension of the short transverse side 44 on the clipping sleeve mount 40.

Each of the two clipping sleeve mounts 40 is an unitary extruded rigid hard plastic hollow band with a top surface 41, a bottom sole 42, two long lengthwise shoulders 43 and two short transverse sides 44, and has an accommodating channel 45 including an upper first accommodating channel 451 and a lower second accommodating channel 452, a longitudinal gap 46, a pair of horizontal clipping juts 47 and a pair of symmetric bevels 38, wherein said accommodating channel 35 is situated between the top surface 31 and bottom sole 32 as well as two short transverse sides 34. The accommodating channel 45 is created between the top surface 41 and bottom sole 42 and extends towards both short transverse sides 44 such that the upper first accommodating channel 451 is wider than the lower second accommodating channel 452. The first accommodating channel 451, which is a flat upper space of the accommodating channel 45 near top surface 41, is dimensioned to have a width and height slightly bigger than the width and height of the elastic metal keelson strip 20 so that the elastic metal keelson strip 20 can be inserted therein. The second accommodating channel 452, which is an adapted flat lower space of the accommodating channel 45, is dimensioned to have a width and height slightly bigger than the width and height of the upper wing section 51 on the elongated scraping blade 50 so that the upper wing section 51 on the elongated scraping blade 50 can be inserted therein. The longitudinal gap 36 is created between the second accommodating channel 452 and bottom sole 42 in parallel with the two long lengthwise shoulders 43 so that the middle neck section 52 in the upper wing section 51 of the elongated scraping blade 50 can be inserted therein. The pair of horizontal clipping juts 47 are created between the external wall of the bottom sole 42 and internal wall of the second accommodating channel 452 to abut against both sides of the longitudinal gap 46 in parallel juxtaposition manner; and a pair of symmetric bevels 48 are created between the internal wall of the upper first accommodating channel 451 and internal wall of the lower second accommodating channel 452 in symmetric manner such that the angle formed by each symmetric bevel 48 along each internal wall of the corresponding first accommodating channel 451 and each internal wall of the corresponding second accommodating channel 452 is an obtuse angle.

The elongated scraping blade 50 is a unitary extruded soft resilient band with an upper wing section 51, a middle neck section 52, and a lower scrapping edge 53. The middle neck section 52 has a pair of symmetric longitudinal grooves formed on both sides thereof in juxtaposition to run through the longitudinal gap 36 on the wiper adapter saddle bracket 30 and a longitudinal gap 46 on the clipping sleeve mount 40.

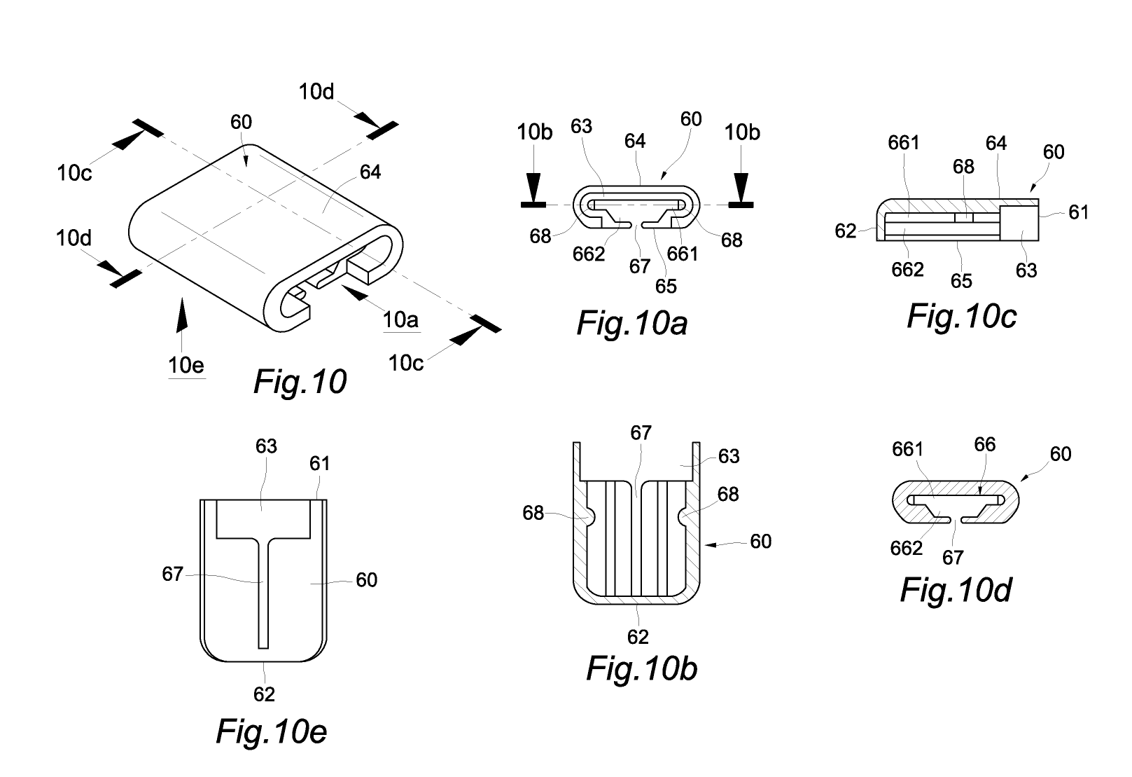

Each of the pair of end positioning caps 60 is a hollow flexible cuboid for serving to cap each corresponding short transverse edge 21 on the elastic metal keelson strip 20, and has a front opening end 61, a rear closed end 62, a pair of widen-slotted inlets 63, a accommodating tunnel 66 including an upper first accommodating tunnel 661 and a lower second accommodating tunnel 662, a longitudinal slit 67, a pair of horizontal internal knurls 68 and two longitudinal shoulders 69 with slight expanding deformation capability, wherein the widened-slotted inlet 63, which extends inwardly in each corresponding front opening end 61 with a bottom front edge cutout, has a cross section profile that is the same as that of the short transverse side 44 on the clipping sleeve mount 40, but with an internal dimension slightly bigger than the external dimension of the short transverse side 44 on the clipping sleeve mount 40. The accommodating tunnel 66 is created between the top surface 64 and bottom sole 65 and extends towards the rear closed end 62 such that upper first accommodating tunnel 661 is wider than lower second accommodating tunnel 662. The first accommodating tunnel 661, which is a flat upper space of the accommodating tunnel 66 near top surface 64, is dimensioned to have a width and height slightly bigger than the width and height of the elastic metal keelson strip 20 so that the elastic metal keelson strip 20 can be insert therein. The second accommodating tunnel 662, which is an adapted flat lower space of the accommodating tunnel 66, is dimensioned to have a width and height slightly bigger than the width and height of the upper wing section 51 on the elongated scraping blade 50 so that the upper wing section 51 on the elongated scraping blade 50 can be inserted therein. The longitudinal slit 67 is created between the second accommodating tunnel 662 and bottom sole 65 in parallel with two long lengthwise shoulders 69 so that the middle neck section 52 in the upper wing section 51 of the elongated scraping blade 50 can be inserted therein. The pair of horizontal internal knurls 68 are disposed in both internal walls of the upper first accommodating tunnel 661 near the rear closed end 62 in juxtaposition for grasping the inserted elastic metal keelson strip 20 in a better holding state (as shown in FIGS. 10b and 10c).

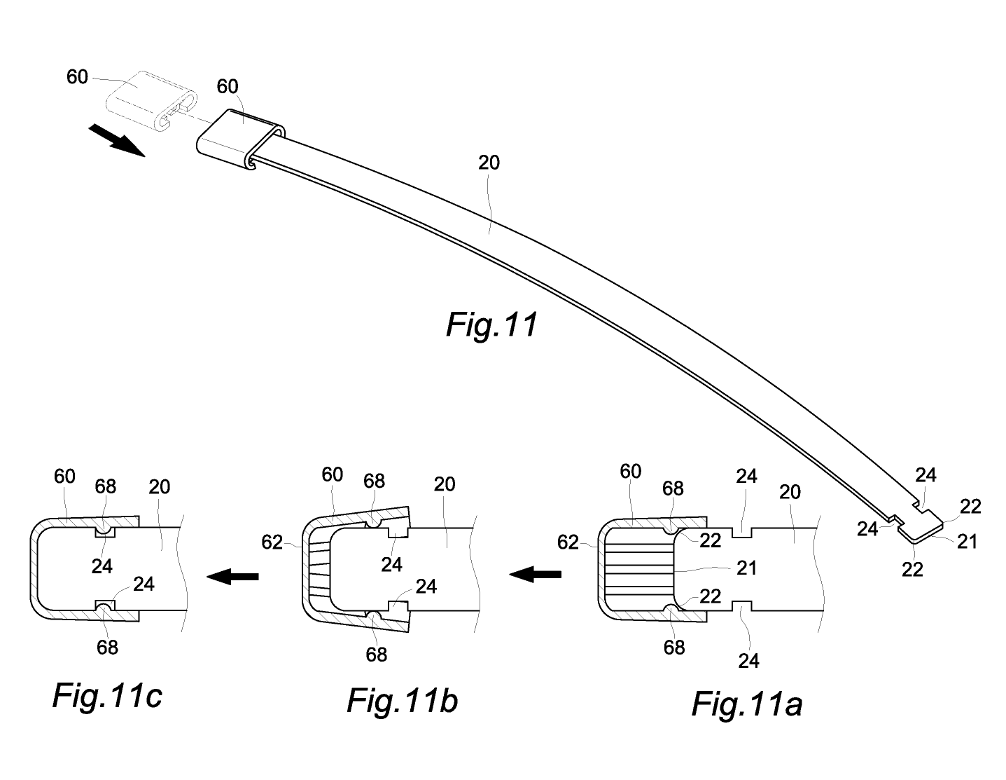

FIGS. 11 through 16 describe the assembly procedure of the above first preferred embodiment of the present invention in steps as follows:

Step a:

First, align and slide the upper first accommodating tunnel 661 in the front opening end 61 of a end positioning cap 60 to the short transverse edges 21 of the elastic metal keelson strip 20 so that both long lengthwise edges 23 of the elastic metal keelson strip 20 can slip into the first accommodating tunnel 661 up to the position where both rounded shoulders 22 of the elastic metal keelson strip 20 are in contact with both horizontal internal knurls 68 of the end positioning cap 60 (as shown in FIG. 11a). Second, inwardly push the elastic metal keelson strip 20 forwards to force both longitudinal shoulders 69 slightly expanding outwardly due to flexible deformation (as shown in FIG. 11b). Third, further push the elastic metal keelson strip 20 forwards to let rounded shoulders 22 of the elastic metal keelson strip 20 pass both horizontal internal knurls 68 of the end positioning cap 60 until both notches 24 thereof engage with both horizontal internal knurls 68 of the end positioning cap 60 with a snapping sound (as shown in FIG. 11c) to finish the engagement step between one end positioning cap 60 and one end of the elastic metal keelson strip 20.

Step b:

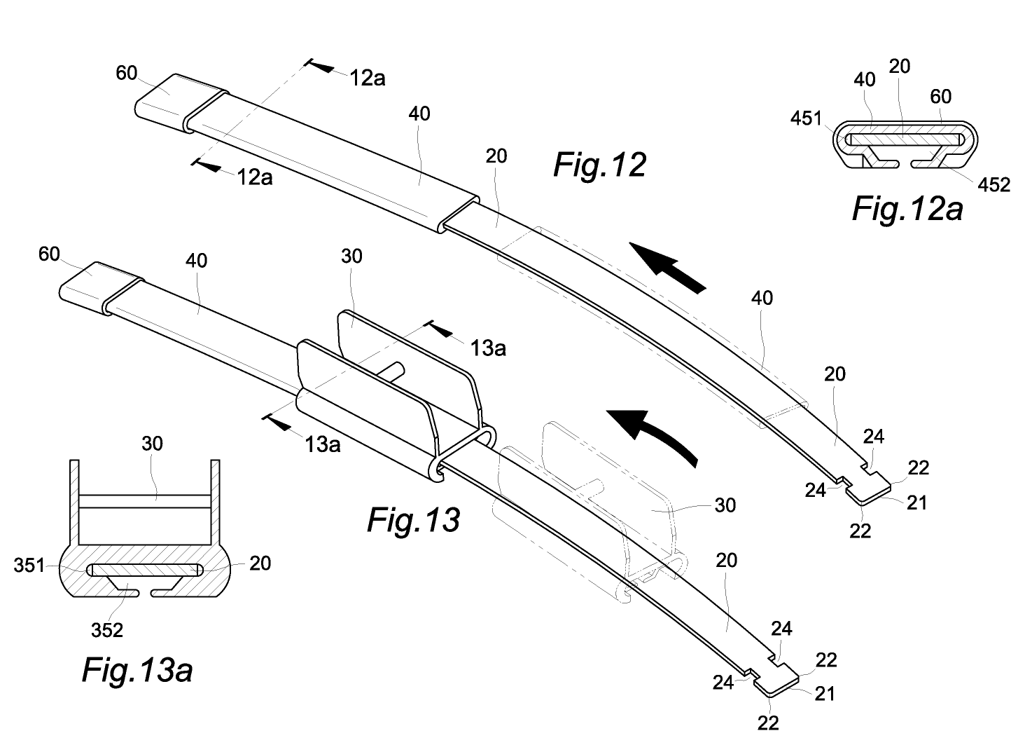

First, pick any clipping sleeve mount 40 then align any short transverse side 44 thereof with the other short transverse edge 21 of the elastic metal keelson strip 20, which is not capped by the end positioning cap 60, and then sleeve the first accommodating channel 451 of the clipping sleeve mount 40 through the elastic metal keelson strip 20 up to the position where the other short transverse edge 21 of the elastic metal keelson strip 20 is in contact with both front opening end 61 of the end positioning cap 60. Second, further push the elastic metal keelson strip 20 forwards to let the rounded shoulders 22 of the elastic metal keelson strip 20 slide fully into the end positioning cap 60 (as shown in FIGS. 12 and 12a).

Step c:

First, align any short transverse side 34 of the wiper adapter saddle bracket 30 with the other short transverse edge 21 of the elastic metal keelson strip 20, which is still not yet capped by the end positioning cap 60, and then sleeve the first accommodating channel 351 of the saddle bracket of wiper adapter 30 through the same elastic metal keelson strip 20 up to the position where the forward short transverse edge 34 of the saddle bracket 30 is in contact with rear short transverse side 44 of the clipping sleeve mount 40. Second, further push the saddle bracket of wiper adapter 30 forwards to let the widen-slotted inlet 39 in the forward short transverse edge 34 of the saddle bracket of wiper adapter 30 sleeve fully over rear short transverse side 44 of the clipping sleeve mount 40 (as shown in FIGS. 13 and 13a);

Step d:

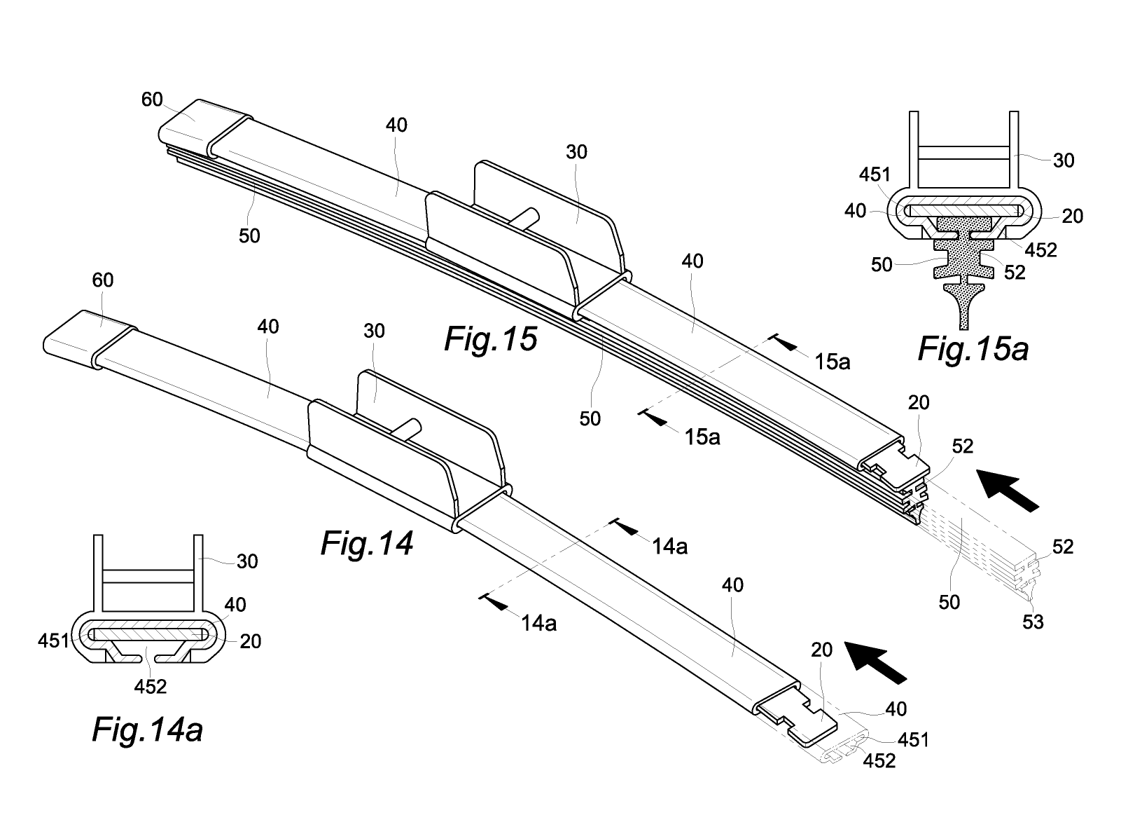

First, follow the operational method in previous step b by picking the other clipping sleeve mount 40 to sleeve over the elastic metal keelson strip 20. Second, further push the clipping sleeve mount 40 forwards to let the forward short transverse side 44 of the clipping sleeve mount 40 slide into the widened-slotted inlet 39 in the rear short transverse edge 34 of the wiper adapter saddle bracket 30 in fully enclosed manner (as shown in FIGS. 14 and 14a).

Step e:

First, align and insert the middle neck section 52 in the upper wing section 51 of the elongated scraping blade 50 into the right second accommodating channel 452 of the clipping sleeve mount 40 as shown in step d. Second, slide and insert the elongated scraping blade 50 forwards to let the lower second accommodating channel 452 of clipping sleeve mount 40 run in order through lower second accommodating channel 352 of the wiper adapter saddle bracket 30 as shown in step c, left second accommodating channel 452 of the clipping sleeve mount 40 as shown in step b, and lower second accommodating tunnel 662 of the end positioning caps 60 as shown in step a. Third, further insert the elongated scraping blade 50 forwards to let the front end thereof contact against the internal wall in the rear closed end 62 of the end positioning caps 60 (as shown in FIGS. 15 and 15a).

Step f:

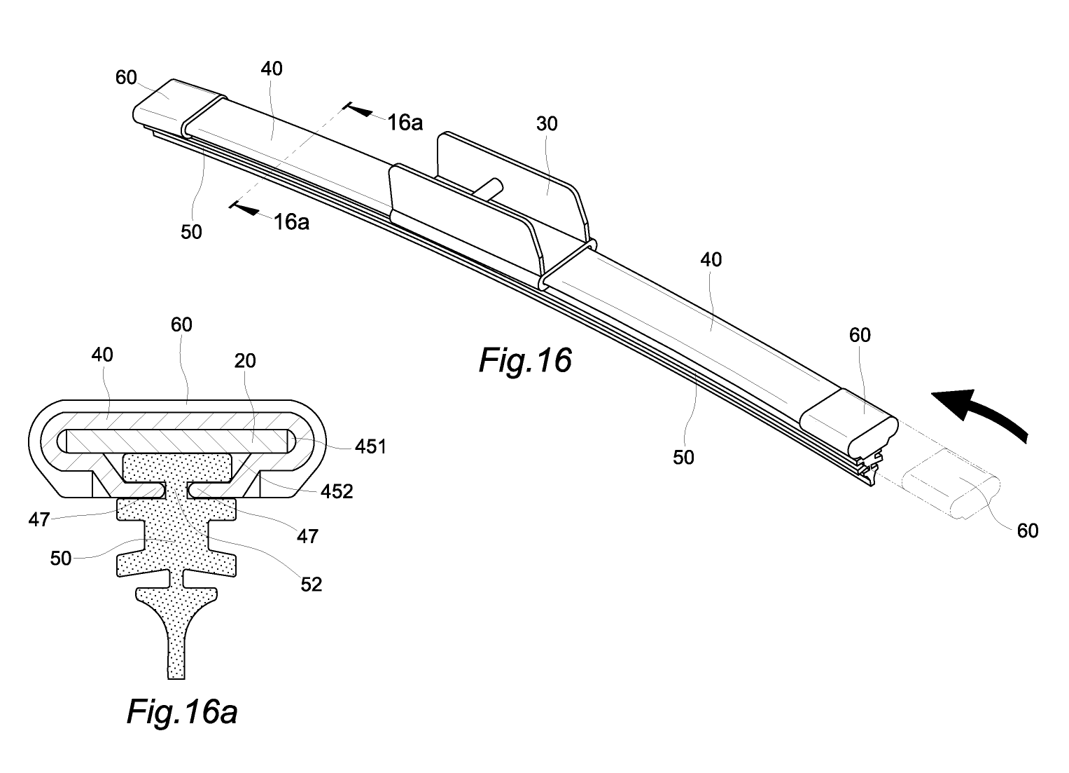

First, follow the operational method in previous step a by aligning and sliding the lower second accommodating tunnel 662 of the end positioning caps 60 over the long lengthwise edges 23 of the elastic metal keelson strip 20 up to the position where both rounded shoulders 22 of the elastic metal keelson strip 20 are in contact with both horizontal internal knurls 68 of the end positioning cap 60. Second, further push the elastic metal keelson strip 20 forwards to let both notches 24 thereof engage with both horizontal internal knurls 68 of the end positioning cap 60 with a snapping sound to finish the entire assembly process (as shown in FIGS. 16 and 16a).

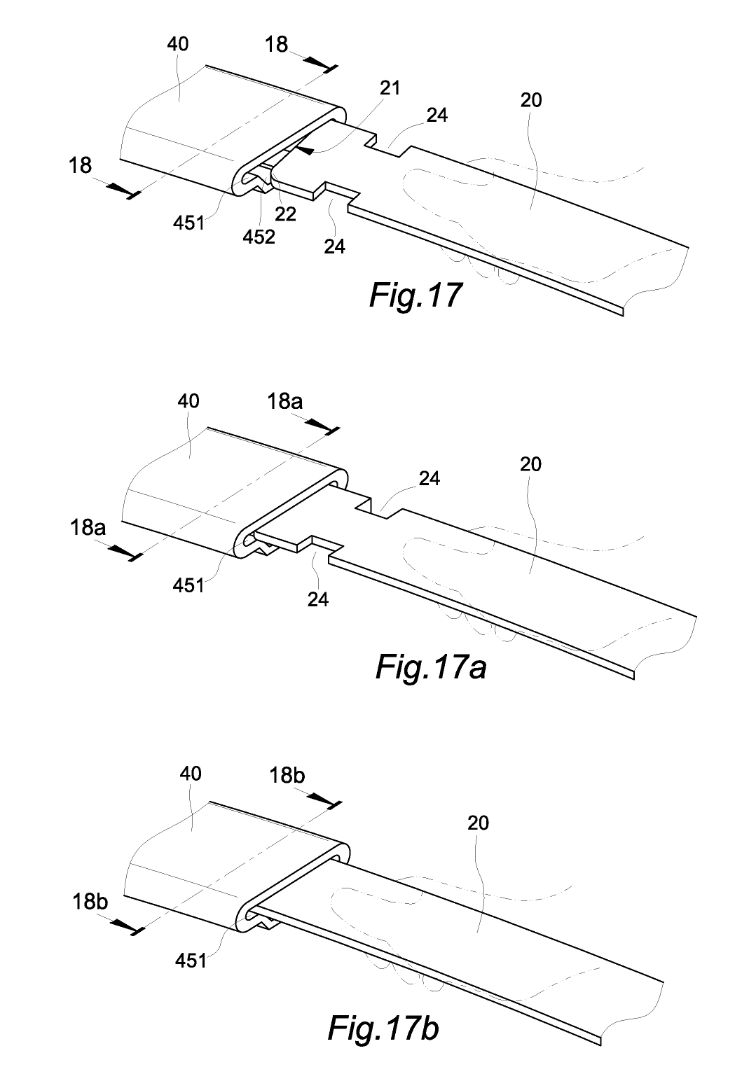

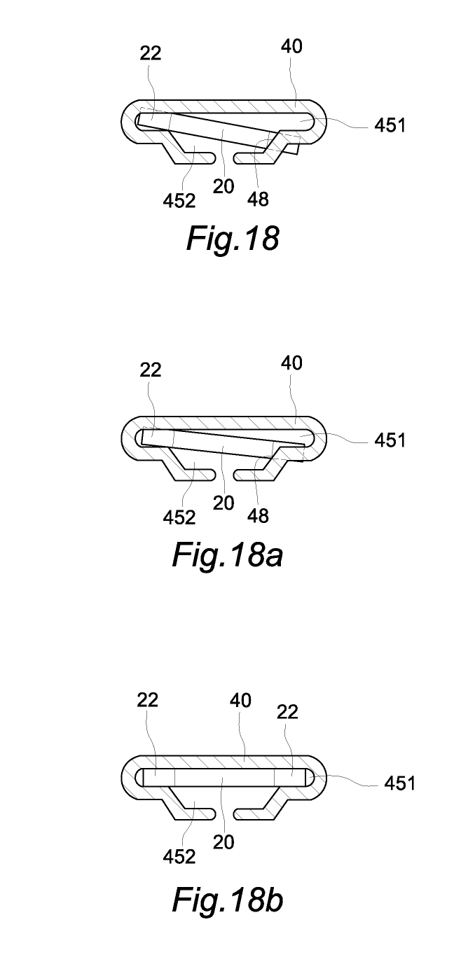

Furthermore refer to FIGS. 17 through 17b and 18 through 18b. The foregoing steps b and d describe the docking procedure of the clipping sleeve mount 40 and the elastic metal keelson strip 20 via corresponding ends respectively. Because the featuring width for the rounded shoulders 22 of each adapted guide section is slightly less than the width of the long lengthwise edges 23, the guide section can serve as an alignment precursor in the docking procedure.

First, for example, even if the adapted guide section with rounded shoulders 22 of the elastic metal keelson strip 20 is not exactly in linear alignment with the upper first accommodating channel 451 of the clipping sleeve mount 40, the adapted guide section with rounded shoulders 22 of the elastic metal keelson strip 20 can be inserted into the clipping sleeve mount 40 since the lower second accommodating channel 452 provides extra tolerance for accommodating the guide section with rounded shoulders 22 (as shown in FIGS. 17 and 18). Second, because of its confinement in the clipping sleeve mount 40 with extra tolerance provided by the lower second accommodating channel 452, the elastic metal keelson strip 20, which is originally not exactly linear alignment with the upper first accommodating channel 451 of the clipping sleeve mount 40, can now be adjusted to be roughly aligned (as shown in FIGS. 17a and 18a); and finally, alignment and docking between the clipping sleeve mount 40 and the elastic metal keelson strip 20 can be further fine tuned to a desired state to complete the docking procedure (as shown in FIGS. 17b and 18b).

With the above-described features, the alignment procedure for key components of the wiper does not need extra care so that fatiguing attention of the assembling operator can be considerably reduced. Accordingly, not only can the assembling time be saved but also the assembling efficiency increased. Consequently, the manufacturing cost is decreased and marketing competition ability is increased.

Moreover, referring to FIGS. 19 through 21, a primary dynamic feature provided in the windshield wiper of the present invention is that the plastic clipping sleeve mount 40 is uniformly rigid hard throughout the entire structure. In practical operation, as mentioned in the “Background of the Invention” section of this specification, because the wiper arm 2 swings back and forth during rain, a forward horizontal force component Fh is exerted on the wiper upon wiper arm 2 as is swings forth, whereas a backward horizontal force component Fh′ is exerted on the wiper upon wiper arm 2 as it swings back. The feature of a rigid hard (clipping sleeve mounts 40) of the present invention provides an effective resistance to the deformation, which usually happens in the soft flexible upper support 4 on the blade body 6 described in U.S. Pat. No. 7,210,189. Thus, in operation, the windshield wiper of the present invention eliminates temporary wiping, jerking, or harsh scraping noises. Consequently, no stress deformation will be incurred so that the service life thereof can be prolonged.

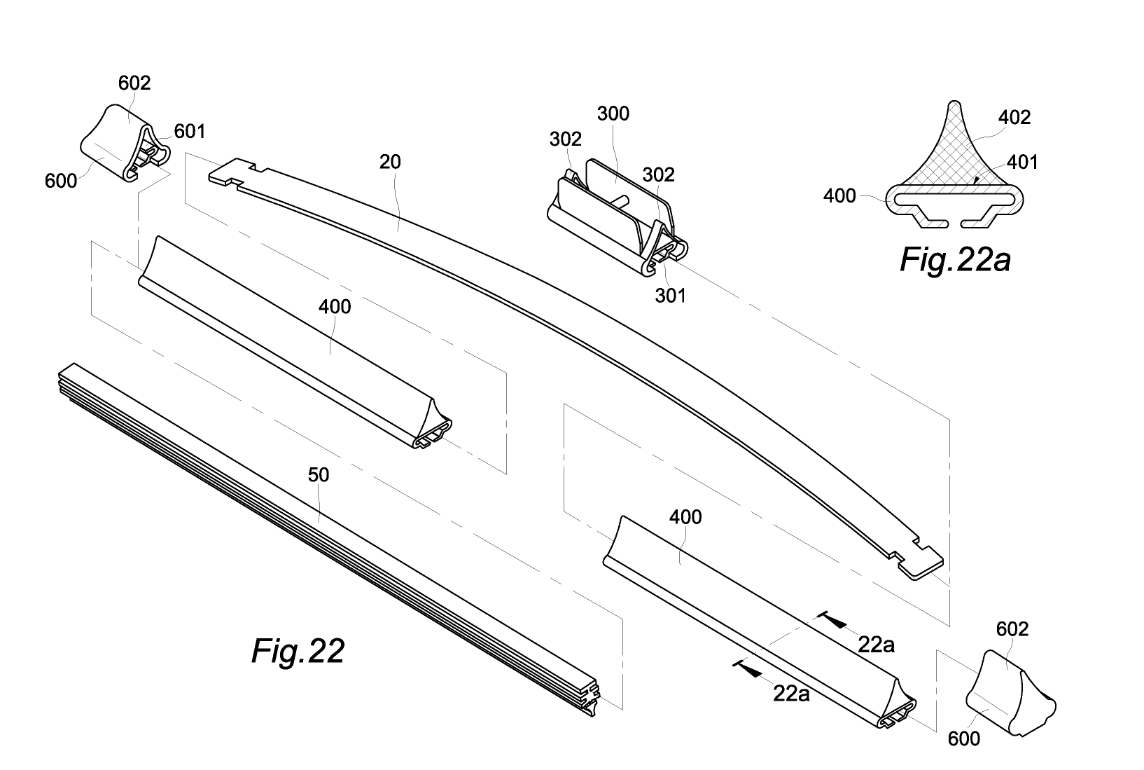

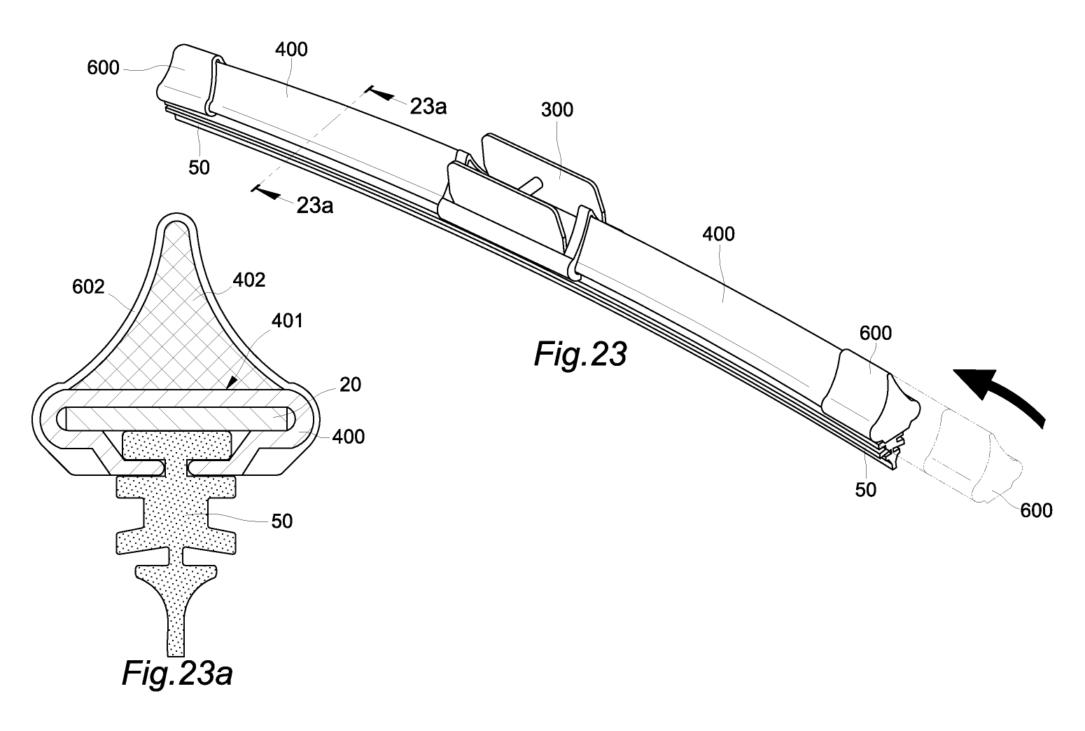

FIGS. 22 and 22a as well as 23 and 23a illustrate a flat blade wiper for a vehicle according to a second preferred embodiment of the present invention. Most components in the second embodiment are identical to corresponding components of the first embodiment described above, but certain components are modified as follows: the wiper adapter saddle bracket 300 is modified with respect to the previously-described wiper adapter saddle bracket 30, clipping sleeve mount 400 is modified from previous clipping sleeve mount 40, and end positioning cap 600 is modified from previous end positioning cap 60. In this embodiment, clipping sleeve mount 400 has a longitudinal ridge 402 and an upward taper shape in cross section profile is provided on a top surface 401 (as shown in FIG. 22a). The wiper adapter saddle bracket 300 has a hollow ridge 302 with an upward taper shape in cross section profile provided on each of two short transverse sides 301 respectively to couple with the longitudinal ridge 402 of the clipping sleeve mount 400. The end positioning caps 600 have a hollow ridge 602 with an upward taper shape in cross section profile is provided on the top surface 601. The cross section profiles of the hollow ridge 302 and hollow ridge 602 are the same as that of the longitudinal ridge 402 but with an internal dimension slightly bigger than the external dimension of the longitudinal ridge 402 on the clipping sleeve mount 400 (as shown in FIG. 23a). By means of the longitudinal ridge 402 on the clipping sleeve mount 400, an equivalent air spoiler is provided in accordance with principles of fluid dynamics when the elongated scraping blade 50 wipes over the windscreen.

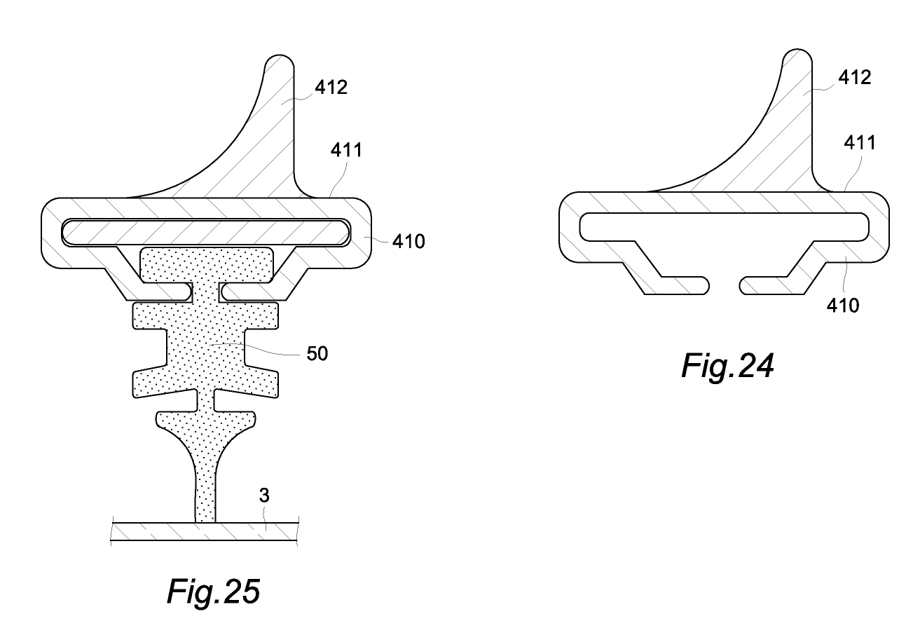

Further referring to FIGS. 24 and 25, the clipping sleeve mount 410 of the second preferred embodiment of the present invention is also modified from previous clipping sleeve mount 40 by providing an asymmetric longitudinal ridge 412 on a top surface 411 to serve as an equivalent air spoiler as well, in accordance with fluid dynamics, when the elongated scraping blade 50 wipes over the windscreen.

What is claimed is:

1. A flat blade wiper, comprising:
an elastic metal keelson strip;
a saddle bracket for receiving a wiper adapter;
two clipping sleeve mounts; and
an elongated scraping blade,
wherein said saddle bracket comprises an accommodating channel including an upper first accommodating channel and a lower second accommodating channel, and a longitudinal gap, said first accommodating channel being wider than said second accommodating channel, said first accommodating channel being arranged to receive said elastic metal keelson strip and said second accommodating channel being arranged to receive an upper wing section of said elongated scraping blade, and edges of said bracket defining said horizontal gap, said gap-defining edges of said bracket being arranged to extend into symmetric longitudinal grooves formed on both sides of a middle neck section of said elongated scraping blade such that said elongated scraping blade extends through said longitudinal gap of said bracket,
wherein each said clipping sleeve mount comprises an accommodating channel including an upper first accommodating channel and a lower second accommodating channel, and a longitudinal slit, said first accommodating channel being wider than said second accommodating channel, said first accommodating channel being arranged to receive said elastic metal keelson strip and said second accommodating channel being arranged to receive said upper wing section of said elongated scraping blade, and edges of said clipping sleeve defining said horizontal slit, said slit-defining edges of said clipping sleeve being arranged to extend into said symmetric longitudinal grooves formed on both sides of said middle neck section of said elongated scraping blade such that said elongated scraping blade extends through said longitudinal slit of said clipping sleeve mount,
wherein said elastic metal keelson strip extends, in order: through said first accommodating channel of a first said clipping sleeve mount, through said first accommodating channel of said bracket, and through said first accommodating channel of a second said clipping sleeve mount,
wherein said elongated scraping blade extends, in order: through said first accommodating channel of a first said clipping sleeve mount, through said first accommodating channel of said bracket, through said first accommodating channel of a second said clipping sleeve mount, and
wherein said bracket is arranged to be mounted on a wiper adapter of a vehicles such that a lower scraping edge of said elongated scraping blade contacts a windshield of the vehicle.

2. A flat blade wiper as claimed in claim 1, further comprising two end positioning caps, wherein each said end positioning cap has an opening end and a closed end and comprises an accommodating tunnel extending from said open end and terminating in said closed end, said accommodating tunnel including an upper first accommodating tunnel and a lower second accommodating tunnel, and a longitudinal slit, said first accommodating tunnel being wider than said second accommodating tunnel, said first accommodating tunnel being arranged to receive an end of said elastic metal keelson strip and said second accommodating tunnel being arranged to receive and end of said upper wing section of said elongated scraping blade, and edges of said clipping sleeve defining said horizontal slit, said slit-defining edges of said end positioning cap being arranged to extend into said symmetric longitudinal grooves formed on both sides of said middle neck section of said elongated scraping blade such that said elongated scraping blade extends through said longitudinal slit of said end positioning cap.

3. A flat blade wiper as claimed in claim 2, wherein said end positioning caps include a pair of horizontal internal knurls that snap into notches in said elastic metal keelson strip to secure said end positioning caps to said elastic metal keelson strip.

4. A flat blade wiper as claimed in claim 2, wherein ends of said accommodating tunnel of each of said end positioning caps for a widened inlet arranged to receive ends of said clipping sleeve mounts, internal dimensions of said widened inlet being slightly larger than external dimensions of said clipping sleeve mounts to enable said ends of said clipping sleeve mounts to fit within said widened inlets of the end positioning caps.

5. A flat blade wiper as claimed in claim 2, wherein each said clipping sleeve mount has a longitudinal ridge with an upward taper shape in cross section that is provided on a top surface; and said saddle bracket has a hollow ridge with an upward taper shape in cross section provided on each of two short transverse sides respectively to couple with the longitudinal ridge of the clipping sleeve mount; and said end positioning caps have a hollow ridge with an upward taper shape in cross section profile is provided on the top surface; wherein the cross section profiles of the hollow ridge and hollow ridge are the same as that of the longitudinal ridge but with internal dimension being slightly bigger than the external dimension of the longitudinal ridge on the clipping sleeve mount.

6. A flat blade wiper as claimed in claim 1, wherein said clipping sleeve mount has an asymmetric longitudinal ridge with an asymmetric upward taper shape in cross section profile provided on a top surface.

7. A flat blade wiper as claimed in claim 1, wherein ends of said accommodating channel of said bracket form a widened inlet arranged to receive ends of said clipping sleeve mounts, internal dimensions of said widened inlet being slightly larger than external dimensions of said clipping sleeve mounts to enable said ends of said clipping sleeve mounts to be inserted into said widened inlets of said bracket.

8. A flat blade wiper as claimed in claim 1, wherein symmetric bevels extend between an internal wall of the respective first accommodating channels and second accommodating channels of the bracket and clipping sleeve mounts, said bevels forming an obtuse angle with said internal walls of the respective first and second accommodating channels.

9. A flat blade wiper as claimed in claim 1, wherein said clipping sleeve mount is a unitary extruded plastic adapted parallelepiped with a top surface, a bottom sole, two long lengthwise shoulders and two short transverse sides, wherein said accommodating channel is situated between the top surface and bottom sole and extends towards both short transverse sides; wherein said first accommodating channel is a flat upper space of the accommodating channel near a top surface and is dimensioned to have a width and height slightly bigger than a width and height of the elastic metal keelson strip; said second accommodating channel is a flat lower space of the accommodating channel and is dimensioned to have a width and height slightly bigger than a width and height of the upper wing section of the elongated scraping blade; wherein said longitudinal slit is between the second accommodating channel and bottom sole in parallel with two long lengthwise shoulders; said edges that define the longitudinal slit being edges of a pair of horizontal clipping juts situated between the external wall of the bottom sole and internal wall of the second accommodating channel to define the sides of the longitudinal gap.

10. A flat blade wiper as claimed in claim 1, wherein said saddle bracket is a unitary bracket having a pair of upright cheeks, and a spindle extending between the cheeks and arranged to be linked to a wiper arm of the vehicle.

11. A flat blade wiper as claimed in claim 1, wherein said elongated scraping blade is a unitary extruded soft resilient band.

12. A flat blade wiper as claimed in claim 1, wherein said elastic metal keelson strip is a flat flexible metal band having a yoke-shaped profile with two ends extending downwardly, a pair of short transverse edges, a pair of long lengthwise edges, a pair of guide sections, two pairs of rounded shoulders and two pair of notches, wherein each said guide section is located at a respective distal end of the elastic metal keelson strip and flanked by the pair rounded shoulders; and said each pair notches are located at joint sides of the long lengthwise edges and corresponding rounded shoulders.

13. A flat blade wiper as claimed in claim 12, wherein each guide section near to each corresponding short transverse edge is adapted to have both lengthwise edges rounded or obtuse-angled.

14. A clipping sleeve mount for a flat blade wiper, comprising an accommodating channel including an upper first accommodating channel and a lower second accommodating channel, and a longitudinal slit, said first accommodating channel being wider than said second accommodating channel, said first accommodating channel being arranged to receive an elastic metal keelson strip and said second accommodating channel being arranged to receive an upper wing section of an elongated scraping blade, and edges of said clipping sleeve defining said horizontal slit, said slit-defining edges of said clipping sleeve being arranged to extend into said symmetric longitudinal grooves formed on both sides of said middle neck section of said elongated scraping blade such that said elongated scraping blade extends through said longitudinal slit of said clipping sleeve mount.

15. A clipping sleeve mount as claimed in claim 14, wherein said clipping sleeve mount is a unitary extruded plastic adapted parallelepiped with a top surface, a bottom sole, two long lengthwise shoulders and two short transverse sides, wherein said accommodating channel is situated between the top surface and bottom sole and extends towards both short transverse sides; wherein said first accommodating channel is a flat upper space of the accommodating channel near a top surface and is dimensioned to have a width and height slightly bigger than a width and height of the elastic metal keelson strip; said second accommodating channel is a flat lower space of the accommodating channel and is dimensioned to have a width and height slightly bigger than a width and height of the upper wing section of the elongated scraping blade; wherein said longitudinal gap is between the second accommodating channel and bottom sole in parallel with two long lengthwise shoulders; said edges that define the longitudinal slit being edges of a pair of horizontal clipping juts situated between the external wall of the bottom sole and internal wall of the second accommodating channel to define the sides of the longitudinal slit.

16. A saddle bracket for receiving a wiper adapter of a vehicle, wherein said saddle bracket comprises an accommodating channel including an upper first accommodating channel and a lower second accommodating channel, and a longitudinal gap, said first accommodating channel being wider than said second accommodating channel, said first accommodating channel being arranged to receive an elastic metal keelson strip and said second accommodating channel being arranged to receive an upper wing section of an elongated scraping blade, and edges of said bracket defining said horizontal gap, said gap-defining edges of said bracket being arranged to extend into symmetric longitudinal grooves formed on both sides of a middle neck section of said elongated scraping blade such that said elongated scraping blade extends through said longitudinal gap of said bracket.

17. A saddle bracket for receiving a wiper adapter of a vehicle, wherein said saddle bracket is a unitary bracket having a pair of upright cheeks, and a spindle extending between the cheeks and arranged to be linked to a wiper arm of the vehicle.

18. A method of assembling a flat blade wiper, comprising the steps of:
providing an elastic metal keelson strip; a saddle bracket for receiving a wiper adapter; two clipping sleeve mounts; and an elongated scraping blade, wherein said saddle bracket comprises an accommodating channel including an upper first accommodating channel and a lower second accommodating channel, and a longitudinal gap, said first accommodating channel being wider than said second accommodating channel, said first accommodating channel being arranged to receive said elastic metal keelson strip and said second accommodating channel being arranged to receive an upper wing section of said elongated scraping blade, and edges of said bracket defining said horizontal gap, said gap-defining edges of said bracket being arranged to extend into symmetric longitudinal grooves formed on both sides of a middle neck section of said elongated scraping blade such that said elongated scraping blade extends through said longitudinal gap of said bracket, wherein each said clipping sleeve mount comprises an accommodating channel including an upper first accommodating channel and a lower second accommodating channel, and a longitudinal slit, said first accommodating channel being wider than said second accommodating channel, said first accommodating channel being arranged to receive said elastic metal keelson strip and said second accommodating channel being arranged to receive said upper wing section of said elongated scraping blade, and edges of said clipping sleeve defining said horizontal slit, said slit-defining edges of said clipping sleeve being arranged to extend into said symmetric longitudinal grooves formed on both sides of said middle neck section of said elongated scraping blade such that said elongated scraping blade extends through said longitudinal slit of said clipping sleeve mount;
inserting said keelson strip in order through respective said first accommodating channels of a first said clipping sleeve mount, said saddle bracket, and a second said clipping sleeve mount; and
inserting said elongated scraping blade in order through respective said second accommodating channels of said first clipping sleeve mount, said saddle bracket, and said second clipping sleeve mount.

19. A method as claimed in claim 18, further comprising the steps of:
providing two end positioning caps, wherein each said end positioning cap has an opening end and a closed end and comprises an accommodating tunnel extending from said open end and terminating in said closed end, said accommodating tunnel including an upper first accommodating tunnel and a lower second accommodating tunnel, and a longitudinal slit, said first accommodating tunnel being wider than said second accommodating tunnel, said first accommodating tunnel being arranged to receive an end of said elastic metal keelson strip and said second accommodating tunnel being arranged to receive and end of said upper wing section of said elongated scraping blade, and edges of said clipping sleeve defining said horizontal slit, said slit-defining edges of said end positioning cap being arranged to extend into said symmetric longitudinal grooves formed on both sides of said middle neck section of said elongated scraping blade such that said elongated scraping blade extends through said longitudinal slit of said end positioning cap;
and fitting said end positioning caps over ends of said elastic metal keelson strip and elongated scraping blade until knurls in said first accommodating tunnel snap into notches in said elastic metal keelson strip.

20. A method as claimed in claim 19, wherein ends of said clipping sleeve mounts are fitted into respective widened inlets of said saddle bracket and end positioning caps.
